(19) United States
(12) Patent Application Publication
(10) Pub. No.: US 2005/0109570 A1
(43) Pub. Date: May 26, 2005

(54) Shock absorber with one-piece fixing component

(75) Inventors: Michael Muller, Hennef (DE); Stefan Brehm, Hennef (DE); Manfred Heinisch, Eitorf (DE)

Correspondence Address: COHEN, PONTANI, LIEBERMAN & PAVANE, 551 FIFTH AVENUE, SUITE 1210, NEW YORK, NY, 10176, US

(73) Assignee: ZF Friedrichshafen AG

(21) Appl. No.: 11/019,430

(22) Filed: Dec. 22, 2004

Related U.S. Application Data
(63) Continuation-in-part of application No. 10/370,122, filed on Feb. 19, 2003.

(30) Foreign Application Priority Data
Jan. 14, 2004 (DE) 10 2004 001 933.9

(51) Int. Cl. F16F 9/00

(52) U.S. Cl. 188/321.11

(57) ABSTRACT

Damping element between two masses, consisting of a container tube, a piston mounted slidably therein in a damping medium, a piston rod connected to this piston, and a fastening part for connecting the container tube to the first of the two masses which are to be isolated from each other with respect to vibration, where the piston rod is connected to one of the masses. The fastening part, consisting of a stem and a fork and serving to connect the fastening part to the first mass, is manufactured as a one-piece component, preferably by forging.

### RELATED APPLICATIONS

This application is a continuation-in-part of U.S. application Ser. No. 10/370,122, filed Feb. 19, 2003, now pending, the disclosure of which is hereby incorporated by reference.

### BACKGROUND OF THE INVENTION

1. Field of the Invention

The invention pertains to a damping element between two masses, consisting of a container tube, a piston slidably mounted therein in a damping medium, a piston rod connected to this piston, and a fastening part or fixing component for connecting the damping element to a first of the two masses which are to be isolated from each other with respect to vibration, the piston rod being connected to one of the masses.

2. Description of the Related Art

Damping elements or shock absorbers of the type indicated above (e.g., U.S. 2003/0160372) are used in motor vehicles, for example, between a first mass, namely, the passenger compartment which is to be isolated from the vibrations, and a second mass, namely, the wheels, which are subject to vibration while the vehicle is being driven. The damping element is connected by means of a piston rod to, for example, the first mass, and by means of a fastening part to the second mass. The piston rod is hinged to a piston, which executes oscillating movements inside a container tube of the damping element, which is connected to the fastening part and filled with damping medium, these oscillating movements corresponding to the vibrational movements of the two masses with respect to each other.

In certain embodiments, the fastening part on the damping element is designed with a fork so that it can be attached pivotably to the second mass. The fork has bores at its two ends, so that the damping element can be supported in an articulated manner on the second mass by means of a pin, which is pushed through the two bores. According to the state of the art, this fork is mounted on a stem, and the stem is mounted in turn on a bottom part of the container tube. This bottom part is a disk, which is welded to the container tube to seal it off. This disk is therefore welded to the stem and the stem is welded to the fork to provide the functions “sealing” and “attachment”.

### SUMMARY OF THE INVENTION

The inventive object of the present invention provides that the two parts, namely, the stem and the fork, are combined into a single part in order to make possible a production method which is low in cost but which, above all, is also suitable for mass production. This single piece can then be connected to the bottom part. In addition, the component also has increased strength. The advantages of this measure are obvious. The fastening part is produced as a forging, because this production method minimizes the amount of metal-removing machining which must be done. The weight of the fastening part can be reduced by designing its dimensions to accommodate the buckling and bending stresses. Special attention is given here to the shaft, the cross section of which can have a profile, which can be, for example, a double-T profile, which presents no difficulties to forging as a production method.

The present invention therefore has the goal of improving the design of the fastening part of a damping element in such a way that the damping element, consisting of a container tube, a piston mounted slidably therein, a piston rod connected to this piston, and a fastening part, can be made available at low cost and assembled with minimal effort.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows a partial cross section of a damping element, consisting of a container tube, a piston rod, and a fastening part;

FIG. 2 shows another view of the damping element illustrated in FIG. 1, where the container tube is partially cut away;

FIG. 3 shows another embodiment of a damping element, in partial cross section;

FIG. 4 shows a partial cross section of a damping element;

FIG. 5 shows another embodiment of a fastening part and its connection to a container tube;

FIG. 6 shows a screwed connection between the fastening part and bottom part; and

FIGS. 7 and 8 show two different embodiments of a fastening part.

### DETAILED DESCRIPTION OF THE PRESENTLY PREFERRED EMBODIMENTS

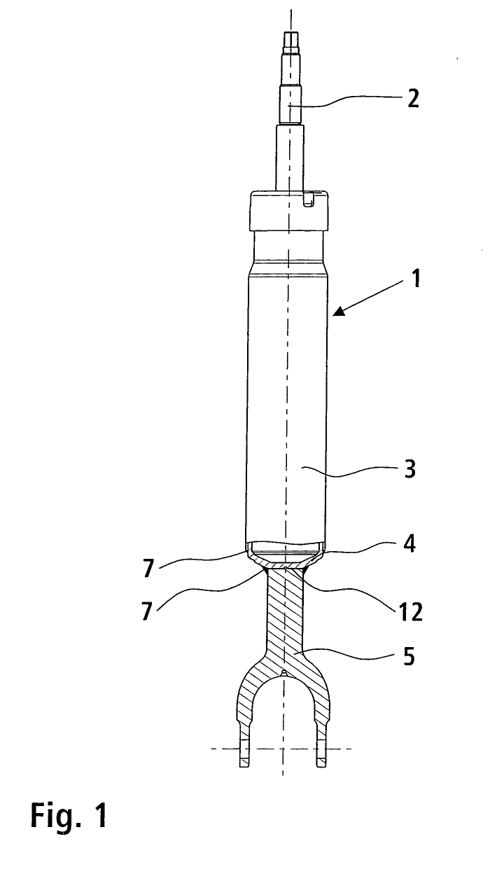

The damping element 1 shown in FIG. 1 consists essentially of the container tube 3, the piston rod 2, and the fastening part 5. The fastening part 5 consists of a fork and a stem which are made as a single place and connected to a base 4. A contact surface 12 is formed between the base 4 and the fastening part 5. The fastening part or fixing component 5 is welded to the base 4, and the base 4 is welded to the container tube 3 by means of welds 7.

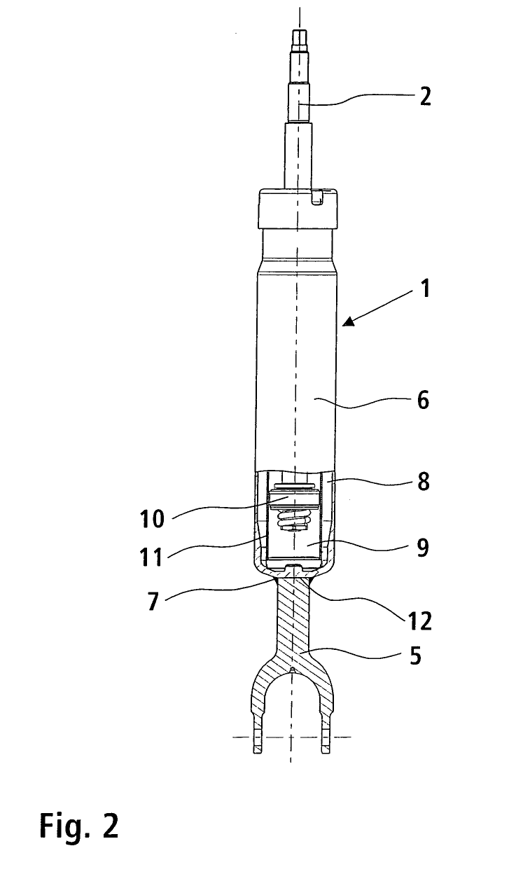

FIG. 2 also shows a damping element 1, which consists of a piston rod 2, a one-piece container tube 6, and the fastening part 5. Inside the container tube 6, a compensating space 8, a working space 9, and a piston 10 can be seen. The working space 9 is formed by an appropriately designed cylinder tube 11. The one-part container tube 6 is connected at its end to the fastening part 5, where, again, a contact surface 12 is formed. At this point, a weld 7 is provided to connect the one-piece container tube to the fastening part 5.

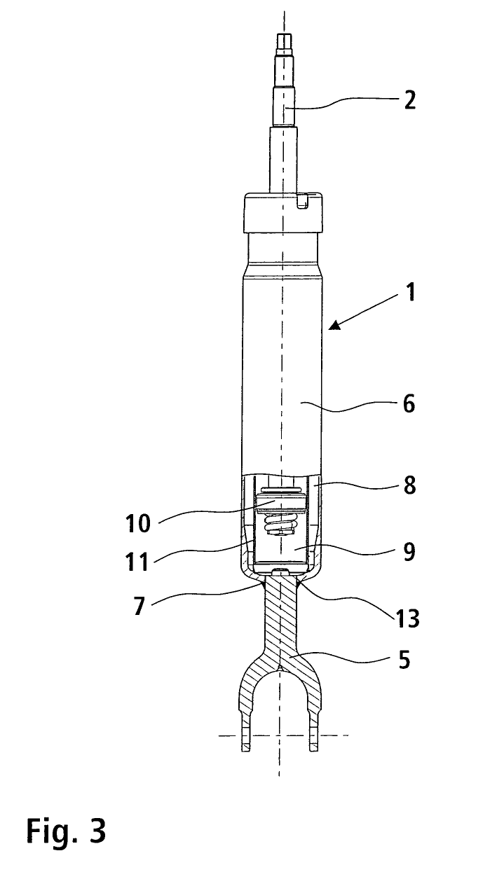

FIG. 3 shows a damping element 1 similar in principle to that of FIG. 2, the difference being that the fastening part 5 is fitted into a bore in the one-piece container tube 6, as a result of which a joint surface 13 is formed, so that a connection between the bottom of the one-piece container tube 6 and the outside circumference of the shaft of the fastening part 5 can be established by a weld 7.

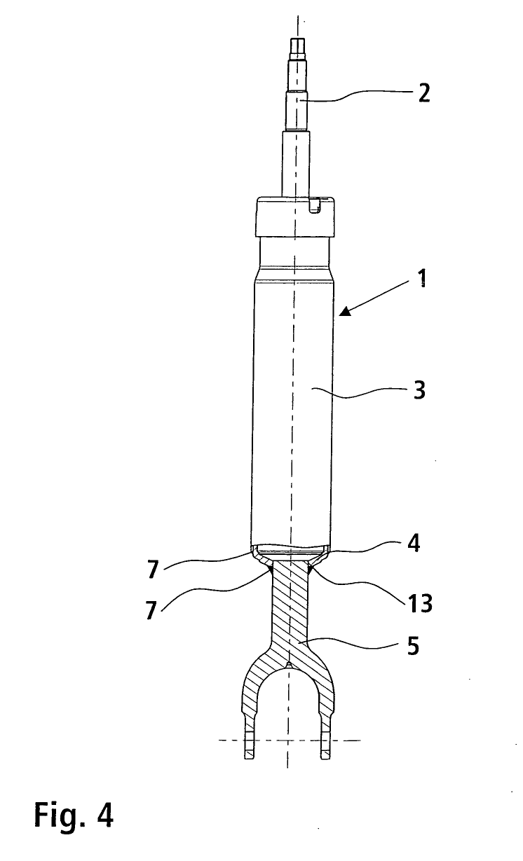

Another embodiment of a damping element 1 can be found in FIG. 4, where a base 4 is provided between the container tube 3 and the fastening part 5. The base 4 has a bore, as already illustrated in FIG. 3, so that the resulting joint surface 13 can be used to connect the fastening part 5 to both the base 4 and to the container tube 3 by welds 7.

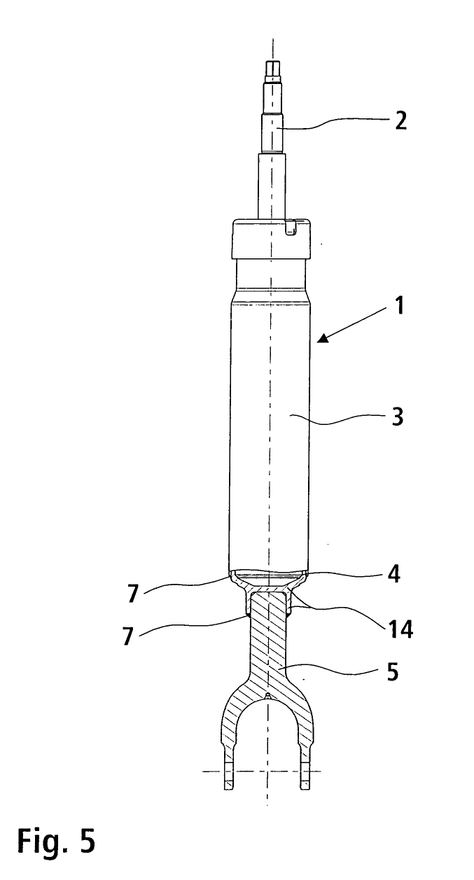

A damping element 1 with a container tube 3 can be seen in FIG. 5, where the base 4 intended to seal off the container tube 3 is provided with a cup 14, into which the stem of the fastening element 5 is fitted. The fastening part 5 is again connected permanently to the base 4 and the base 4 to the container tube 3 by welds 7.

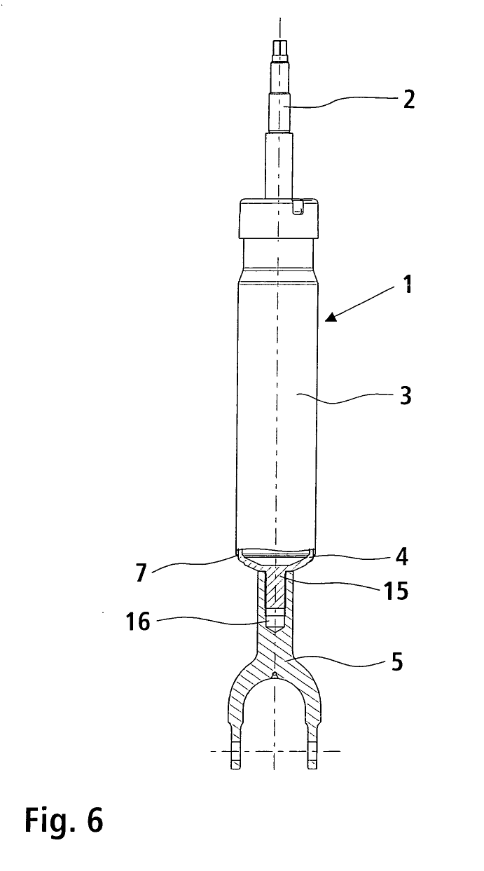

FIG. 6 shows a damping element 1, where the container tube 3 is sealed by a base 4; the base 4 is provided here with a pin 15, which is fitted into a bore 16 in the fastening part 5. The connection between the pin 15 and the fastening part 5 is accomplished in this case by way of a threaded joint, but other means of connecting the two parts could also be used such as press-fitting, bonding, welding, joining, peening, or brazing. The base 4 and the fastening part 5 are permanently connected to the container tube 3 by the weld 7.

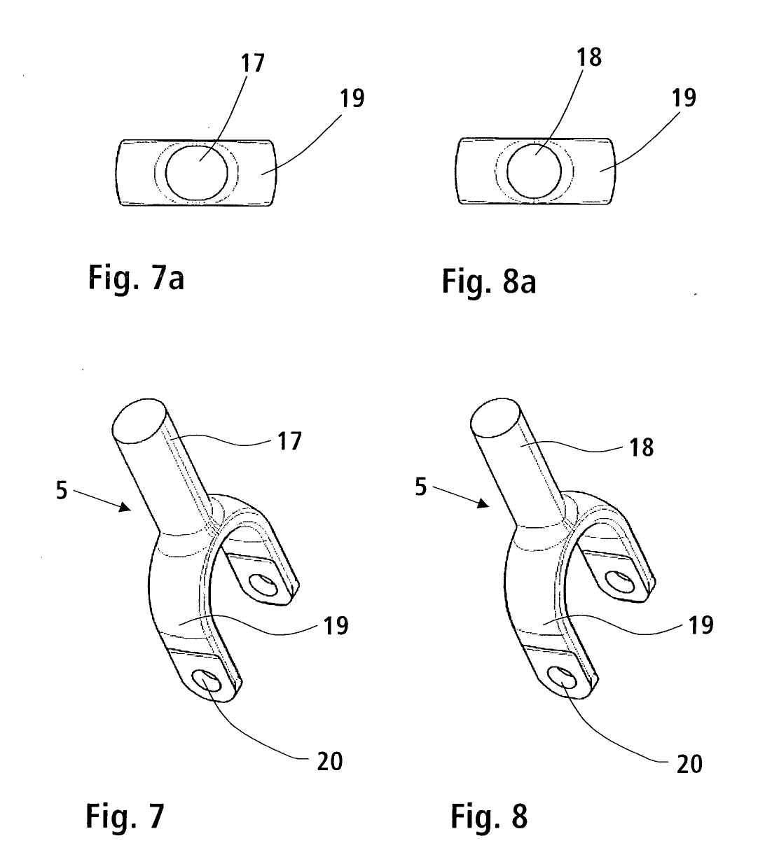

FIGS. 7-7a show a fastening part 5, in which the fork 19 is provided with fastening bores 20 for the connection of the damping element to a vehicle. The stem 17, forming a single piece with the fork 19, has an oval cross section. FIG. 7a shows a plan view of this.

FIGS. 8 and 8a again show a fastening part 5, in which the fork 19 is also a designed to form a single unit with the stem 18. The stem 18 has a round cross section, as can be seen FIG. 8a.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A shock absorber for installation between two masses, said shock absorber comprising:
a container tube containing a damping medium;
a base fixed to said container tube;
a piston arranged in said container tube for displacement in said damping medium;
a piston rod connected to said piston and being connectable to one of said masses; and
a fixing component comprising a stem and a fork which are made as a single piece, said stem being fixed to said base, said fork being connectable to the other of said masses.

2. The shock absorber of claim 1 wherein the fixing component is a forged component.

3. The shock absorber of claim 1 wherein the fixing component is made of steel.

4. The shock absorber of claim 1 wherein the stem has a double-T cross-section.

5. The shock absorber of claim 1 wherein the base comprises an extension which is received in the container tube and a shoulder which abuts the container tube.

6. The shock absorber of claim 5 wherein the extension is received in the container tube in a press fit.

7. The shock absorber of claim 1 wherein the base is welded to the container tube.

8. The shock absorber of claim 1 wherein the fixing part consists of the stem and the fork.

9. The shock absorber of claim 8 wherein the stem is welded to the base.

10. The shock absorber of claim 8 wherein the base comprises a central bore, the stem being received in the central bore and welded to the base.

11. The shock absorber of claim 8 wherein the base is formed as one piece with the container tube.

12. The shock absorber of claim 8 wherein the base is formed with a cup which receives the stem.

13. The shock absorber of claim 8 wherein the base is formed with a pin and the stem is formed with a bore which receives the pin.

14. The shock absorber of claim 13 wherein the pin and the stem having mating threads.
